(19) United States
(12) Patent Application Publication
(10) Pub. No.: US 2026/0036992 A1
(43) Pub. Date: Feb. 5, 2026

(54) Dynamic Obstacle Margin Adjustment For Vehicles And Related Methods

(71) Applicant: Skydio, Inc., San Mateo, CA (US)

(72) Inventors: James Anthony Ferrandini, San Rafael, CA (US); Nathan Leo Bucki, San Mateo, CA (US)

(21) Appl. No.: 19/288,524

(22) Filed: Aug. 1, 2025

Related U.S. Application Data
(60) Provisional application No. 63/678,147, filed on Aug. 1, 2024.

(51) Int. Cl. G05D 1/622; B64U 10/14; G05D 1/222; G05D 1/65; G05D 109/25

(52) U.S. Cl. CPC G05D 1/637; G05D 1/222; G05D 1/65; B64U 10/14; B64U 2201/10; G05D 2109/254

(57) ABSTRACT

Disclosed is a method and system for dynamic obstacle avoidance in unmanned aerial vehicles (UAVs). The approach involves dynamically modifying an obstacle margin based on detected conditions to enable navigation through confined areas. It includes automatically shrinking the obstacle margin when the UAV is in a reduced obstacle mode and limiting the maximum speed of the UAV to a predetermined value in this mode. The system also reduces the size of an obstacle map to enhance resolution and improve detection of confined spaces. Additionally, it dynamically determines detected conditions to automatically adjust the level of obstacle avoidance and detects when the reduced obstacle mode can be exited, allowing the UAV to return to a previous mode.

### CROSS-REFERENCE TO RELATED APPLICATION(S)

This application claims the benefit of U.S. Provisional Patent Application No. 63/678,147, filed Aug. 1, 2024, the entire disclosure of which is hereby incorporated by reference.

### TECHNICAL FIELD

The disclosure relates to a dynamic obstacle avoidance system for vehicles, and more particularly, to a system that dynamically adjusts obstacle margins and speed based on environmental conditions and user inputs.

### BACKGROUND

Unmanned Aerial Vehicles (UAVs), commonly known as drones, have become increasingly prevalent in various sectors, including delivery services, surveillance, agriculture, and recreational activities. As these vehicles operate in diverse environments, they encounter numerous challenges, particularly in navigating through complex and dynamic spaces. Traditional obstacle avoidance systems in UAVs rely on pre-set parameters and manual inputs to navigate around obstacles, which can be limiting in rapidly changing environments. This necessitates the development of more adaptive systems that can respond to real-time conditions without constant human intervention.

The need for improved obstacle avoidance systems is further emphasized by the growing demand for UAVs to operate in urban environments, where they must maneuver through narrow spaces such as doorways, alleys, and between buildings. These environments present unique challenges, as UAVs must be able to adjust their flight paths dynamically to avoid collisions while maintaining efficient operation. Additionally, factors such as wind conditions and tracking errors can significantly impact the UAV's ability to navigate safely. Therefore, there is a pressing need for advanced systems that can autonomously adjust to these variables, ensuring both the safety and efficiency of UAV operations.

### SUMMARY

The method for dynamic obstacle avoidance in an unmanned aerial vehicle (UAV) may involve dynamically modifying an obstacle margin based on detected conditions to enable navigation through confined areas. The method can automatically shrink the obstacle margin when the UAV is in a reduced obstacle mode and limit the maximum speed of the UAV to a predetermined value in this mode. The method may also reduce the size of an obstacle map to enhance resolution and improve detection of confined spaces. Additionally, the method can dynamically determine the detected conditions to automatically adjust the level of obstacle avoidance and detect when the reduced obstacle mode can be exited, automatically returning the UAV to a previous mode upon such detection.

The system for dynamic obstacle avoidance in a UAV may include a processor configured to perform similar functions as the method. The processor can dynamically modify an obstacle margin based on detected conditions, automatically shrink the obstacle margin in reduced obstacle mode, limit the maximum speed of the UAV, reduce the size of an obstacle map, dynamically determine detected conditions, and automatically adjust the level of obstacle avoidance. The processor may also detect when the reduced obstacle mode can be exited and automatically return the UAV to a previous mode.

In some examples, the detected conditions may include impeded movement of the UAV or an intended path through a restricted opening. The method can involve adaptively adjusting the obstacle margin based on the confined area, dynamically reducing the obstacle margin, setting an adjustable limit for reduced velocity, and enhancing the precision of the obstacle map for improved recognition of confined spaces. The method may also autonomously recognize criteria for a change in the obstacle avoidance mode and autonomously revert to the previous mode.

The system may also include similar functionalities where the detected conditions can involve impeded movement or an intended path through a restricted opening. The system can adaptively adjust the obstacle margin, dynamically reduce the obstacle margin, set an adjustable limit for reduced velocity, and enhance the precision of the obstacle map. The system may autonomously recognize criteria for a change in the obstacle avoidance mode and autonomously revert to the previous mode.

The method may further include receiving user input from a controller to temporarily reduce the obstacle margin or toggle between multiple obstacle avoidance modes. Similarly, the system's processor can be configured to receive user input to temporarily reduce the obstacle margin or toggle between different obstacle avoidance modes.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example configuration of a top side of an unmanned aerial vehicle (UAV), consistent with various embodiments.

FIG. 2 illustrates an example configuration of a bottom side of the UAV, consistent with various embodiments.

FIG. 3 illustrates an example UAV architecture, consistent with various embodiments.

FIG. 4 illustrates a GUI showing UAV obstacle avoidance modes with varying distances consistent with various embodiments.

FIG. 5 illustrates UAV obstacle avoidance modes: Default, Close, and Minimal, indicating different obstacle margin settings consistent with various embodiments.

FIG. 6 illustrates a flowchart showing the decision-making process for dynamic obstacle avoidance in UAVs, focusing on adjusting safety margins based on conditions like geofence return, autonomous movement, and waypoint usage, consistent with various embodiments.

FIG. 7 illustrates a system for enhancing UAV navigation through dynamic obstacle margin adjustments and speed control consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

Disclosed are embodiments for dynamic obstacle avoidance in unmanned aerial vehicles (UAVs). The system may dynamically modify obstacle margins based on detected conditions, allowing the UAV to navigate through confined areas. The UAV may automatically shrink the obstacle margin when in a reduced obstacle mode, such as a “doorway mode,” to fit through narrow spaces. The system may limit the UAV's maximum speed to a predetermined value in this mode to ensure safety. Additionally, the UAV may reduce the size of the obstacle map to enhance resolution and improve detection accuracy in confined spaces. The system may dynamically determine detected conditions to adjust the level of obstacle avoidance automatically. Upon detecting that the reduced obstacle mode can be exited, the UAV may automatically return to its previous mode. The system may also allow user input from a controller to temporarily reduce the obstacle margin or toggle between different obstacle avoidance modes, providing user control over the UAV's navigation.

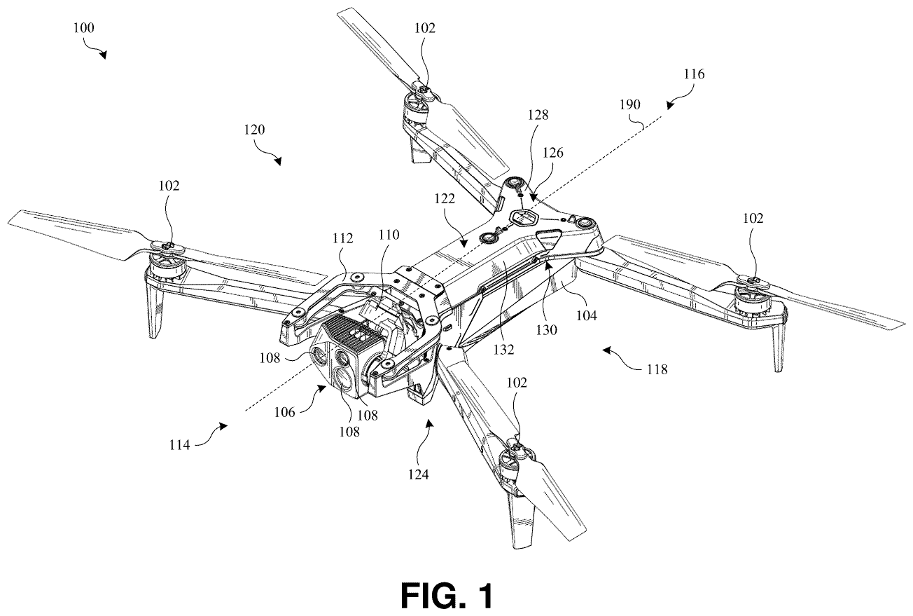

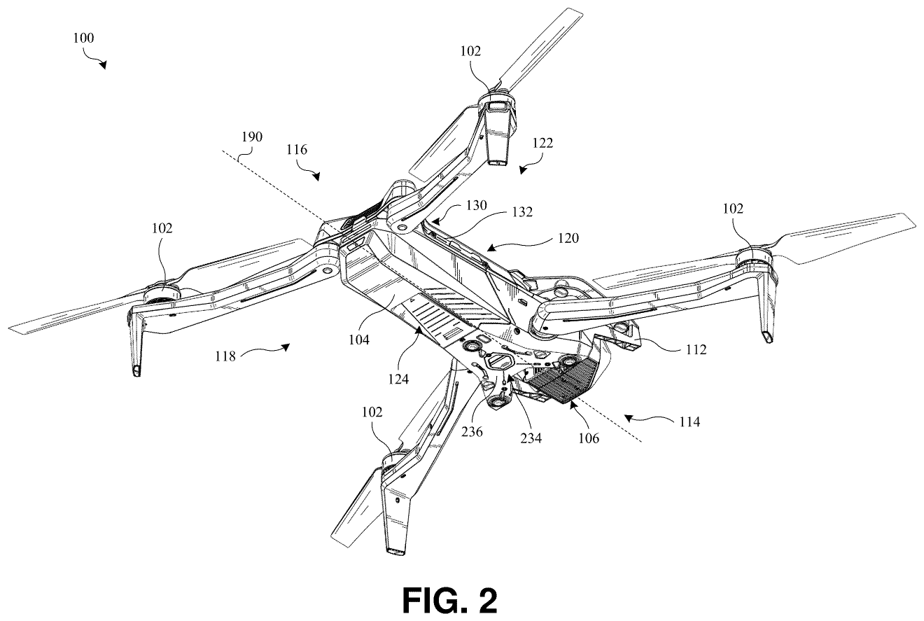

Turning now to the figures, FIG. 1 illustrates a top perspective view of an unmanned aerial vehicle (UAV) 100. FIG. 2 illustrates a bottom perspective view of the UAV 100.

The UAV 100 may include one or more propulsion mechanisms 102 and a power source, such as a battery coupled to the UAV 100. The UAV 100 may be configured for autonomous landing and/or docking with a docking station. To support the autonomous landing and/or docking, the UAV 100 may follow any suitable processes or procedures, or may include one or more components, such as those described in U.S. application Ser. No. 16/991,122, filed Aug. 12, 2020, and U.S. Provisional Application No. 63/527,261, filed on Jul. 17, 2023, the entire disclosures of which are hereby incorporated by reference for all purposes.

The propulsion mechanisms 102 may include any components and/or structures suitable for supporting flight of the UAV 100. For example, as shown in FIGS. 1 and 2, the propulsion mechanisms 102 may be or may include propeller assemblies having one or more blades connected to hubs of the UAV 100. The one or more blades may be propelled by a motor to rotate the one or more blades and facilitate flight of the UAV 100, whereby the motor may be powered by a power source of the UAV 100, such as the battery 104. It should be appreciated, however, that the configuration and/or structure of the UAV 100 may vary depending on the particular configuration of the UAV 100, and as such, the UAV 100 shown in FIG. 1 is not intended to limit the structure of the UAV 100.

As mentioned above, the UAV 100 may be configured using various processes or protocols to autonomously land (e.g., on a docking station), to autonomously take flight (e.g., from a docking station), or both. To facilitate autonomous landing and/or autonomous flight, the UAV 100 may include one or more sensors, such as image sensors, that are configured to monitor a position of the UAV 100 and/or detect a specified image, such as a fiducial disposed on a docking station. For example, during a landing sequence (e.g., a docking sequence) of the UAV 100, the image sensors of the UAV 100 may detect an image, such as the fiducial disposed on the docking station, to properly align and guide the UAV 100 to dock.

The UAV 100 may further include a camera system 106. The camera system 106 may be configured to detect, monitor, capture, record, or a combination thereof one or more images. The camera system 106 may be configured to facilitate autonomous or user-controlled flight of the UAV 100. For example, the camera system 106 may include one or more cameras 108. The cameras 108 may capture a live feed of an environment during flight, whereby a user via a user interface (e.g., a controller) may control the UAV 100 based upon the live feed of the environment. Alternatively, or additionally, the cameras 108 may capture images of the environment and/or monitor the environment in real-time to autonomously fly through the environment. It should be noted that the cameras 108 and the camera system 106 are not limited to any particular configuration, and any types of camera configurations (e.g., wide-angle, high-resolution, etc.) may be implemented in the UAV 100.

The camera system 106 may be operable via a gimbal system 110 coupled to the camera system 106. The gimbal system 110 may be configured to be controlled autonomously or via a user interface (e.g., a controller) to orient or otherwise move the camera system 106 (e.g., the cameras 108) relative to the UAV 100. The gimbal system 110 may include one or more arms and one or more pivot joints that facilitate movement of the camera system 106 relative to the UAV 100.

The gimbal system 110 and the camera system 106 may be coupled to the UAV 100 by a mounting bracket 112. The mounting bracket 112 may be coupled to the UAV 100 by one or more fasteners or other mechanical connection means to secure the gimbal system 110 and the camera system 106 to the UAV 100. The mounting bracket 112 may be coupled to any portion of the UAV 100. By way of example, as shown in FIGS. 1 and 2, the mounting bracket 112 may be coupled to a front 114 (i.e., a front side) of the UAV 100 or a top 122 (i.e., a top side) of the UAV 100 such that the camera system 106 may be positioned in the front 114 of the UAV 100.

That is, the camera system 106 may be located at the front 114 (i.e., the front side) of the UAV 100 so that the cameras 108 may capture an environment in front of the UAV 100 with respect to a forward direction of travel of the UAV 100 (e.g., a direction of travel of the UAV 100 that is substantially parallel to the ground or along the ground). However, in certain configurations, the camera system 106 may also be coupled to another portion of the UAV 100, such as a rear 116 (i.e., rear side) of the UAV 100, a first side 118 of the UAV 100, a second side 120 of the UAV 100, a bottom 124 (i.e., a bottom side) of the UAV 100, or a combination or variation thereof.

As discussed in further detail below, one or more attachments may be coupled to the UAV 100 and operable with the UAV 100 to further customize a user experience of the UAV 100. That is, the one or more attachments may be coupled to the UAV 100 to provide additional functionality to the UAV 100. For example, the one or more attachments may be a global positioning system (GPS) attachment, a microphone and/or speaker attachment, a night vision attachment (e.g., infrared (IR) attachment), a spotlight attachment, a secondary power source attachment (e.g., a secondary battery similar to the battery 104), an antenna or other radio accessory, a secondary camera system similar to or different from the camera system 106, a computer module, or a combination thereof. Thus, it is envisioned that any type of attachments or arrangement of multiple attachments may be configured for securement to the UAV 100. Additionally, as discussed in further detail below, the UAV 100 or a system thereof may be dynamic such that one or more characteristics (e.g., features, functionalities, operations, etc.) of the UAV 100 may be automatically and dynamically adjusted based upon a type of attachment coupled to the UAV 100.

To facilitate coupling one or more attachments to the UAV 100, the UAV 100 may include one or more attachment interfaces. As shown in FIGS. 1 and 2, the UAV 100 may include a plurality of attachment interfaces located on the UAV 100. For example, the UAV 100 may include a top attachment interface 126 located on the top 122 (i.e., the top side) of the UAV 100, a side attachment interface 130 located on the first side 118 of the UAV 100, a side attachment interface 130 located on the second side 120 of the UAV 100 that opposes the first side 118, and a bottom attachment interface 234 located on the bottom 124 (i.e., the bottom side) of the UAV 100.

To further illustrate positioning of such attachment interfaces, as shown in FIGS. 1 and 2, the UAV 100 (e.g., a body of the UAV 100 from which the propulsion mechanisms 102 extend) may extend along a longitudinal axis 190 of the UAV 100 from the front 114 of the UAV 100 to the rear 116 of the UAV 100. That is, the UAV 100 may extend from a first end (e.g., the front 114, which may be considered a forward end of the UAV 100) to an opposing second end (e.g., the rear 116, which may be considered an aft end of the UAV 100) along the longitudinal axis 190, whereby a length of the UAV 100 or a body thereof may be measured from the first end to the second end.

Moreover, the first side 118 of the UAV 100 may oppose the second side 120 of the UAV 100 with respect to the longitudinal axis 190. The first side 118 and second side 120 may be located on opposing sides of the longitudinal axis 190. The first side 118 may be considered a port side of the UAV 100 and the second side 120 may be considered a starboard side of the UAV 100.

Based on the above relative orientations, it can be seen in FIGS. 1 and 2 that the attachment interfaces described above may be positioned in various locations with respect to the longitudinal axis 190 of the UAV 100. For example, the top attachment interface 126 and/or the bottom attachment interface 234 may be located on the top 122 (i.e., the top side) of the UAV 100 and may extend along the longitudinal axis 190 between the first end (e.g., the front 114 or forward end) and the second end (e.g., the rear 116 or aft end) of the UAV 100. Additionally, the side attachment interfaces 130 may be located on the first side 118 and the second side 120 of the UAV 100 such that the side attachment interfaces 130 may be located on opposing sides of the longitudinal axis 190. That is, a first one of the side attachment interfaces 130 may be located on the port side (e.g., the first side 118) of the UAV 100 and a second one of the side attachment interfaces 130 may be located on the starboard side (e.g., the second side 120) of the UAV 100 such that the side attachment interfaces 130 are located on opposing sides of the longitudinal axis 190.

It should be noted that the above relative orientations associated with the UAV 100 are provided for illustrative purposes and should not be construed as limiting the teachings herein. For example, although the front 114 of the UAV 100 may be considered the front end of the UAV 100 and the rear 116 of the UAV 100 may be considered the aft end of the UAV 100, such considerations do not mean that the UAV 100 only travels in a forward direction with the front 114 of the UAV 100 leading the travel. That is, the UAV 100 may travel in any direction (e.g., fore, aft, side-to-side between the port and starboard sides, in an elevational direction, etc.) with respect to the longitudinal axis 190.

Turning now back to the attachment interfaces, it should be noted that such attachment interfaces may be integrated into the UAV 100, such as a housing of the UAV 100, or may be connected to the UAV 100 to allow for attachment of various attachments. That is, the attachment interfaces may provide a connection means to easily and removably couple various attachments to the UAV 100.

By way of example, the top attachment interface 126 may include a top attachment surface 128. The top attachment surface 128 may be located on, or formed with, the top (i.e., the top side) of the UAV 100. The top attachment surface 128 may be configured to receive, support, or otherwise couple to—either directly or indirectly—various attachments. Similarly, the side attachment interfaces 130 may include a side attachment surface 132 located on, or formed with, the first side 118 and/or the second side 120 of the UAV 100. Moreover, the bottom attachment interface 234 may include a bottom attachment surface 236 located on, or formed with, the bottom 124 (i.e., the bottom side) of the UAV 100. Any number of these attachment surfaces may exist for any of the attachment interfaces. That is, an attachment interface may include more than one attachment surface (e.g., a first attachment surface and a second attachment surface).

Based on the above, one or more attachments may be coupled to the top 122 of the UAV 100, the bottom 124 of the UAV 100, the first side 118 of the UAV 100, the second side 120 of the UAV 100, or a combination thereof. Additionally, it is envisioned that the front 114 and/or the rear 116 of the UAV 100 may also in certain configurations include an additional attachment interface. For example, in certain configurations the UAV 100 may remove the camera system 106 from the front 114 of the UAV and couple the camera system 106 to the UAV 100 in another location (e.g., the rear 116). In such a configuration, the front 114 may include an attachment interface for further attachments.

It should also be noted that the attachment interfaces of the UAV 100 may be adapted for universal or common attachment techniques. That is, various types of attachments may be coupled to the same attachment interface. For example, the GPS attachment and the night vision attachment may both be configured to attach to the top attachment interface 126 and the bottom attachment interface 234. Additionally, more than one attachment may be coupled to the UAV 100 at one time and may be powered by the power source (e.g., the battery 104) of the UAV 100. For example, a first attachment (e.g., a GPS attachment) may be coupled to the top attachment interface 126 and a second attachment (e.g., a spotlight attachment) may be coupled to the side attachment interface 130 located on the first side 118 of the UAV 100. Moreover, the attachment interfaces may include one or more additional features, such as heat-sinking components or other cooling components. Based on the above, various configurations and customization may be possible.

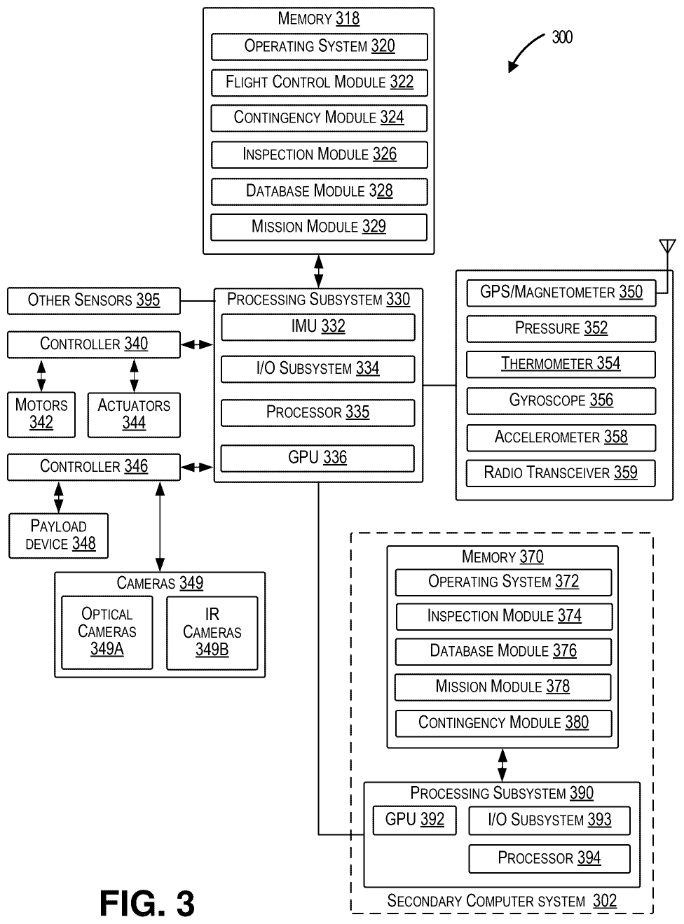

FIG. 3 illustrates an example UAV architecture, consistent with various embodiments. In the examples herein, the UAV 100 may sometimes be referred to as a “drone” and may be implemented as any type of UAV capable of controlled flight without a human pilot onboard. For instance, the UAV 100 may be controlled autonomously by one or more onboard processors, such as processor 335, that execute one or more executable programs. Additionally, or alternatively, the UAV 100 may be controlled via a remote controller, such as through a remotely located controller operated by a human pilot and/or controlled by an executable program executing on or in cooperation with the controller.

A UAV can include a primary computer system 300 and a secondary computer system 302. The UAV primary computer system 300 can be a system of one or more computers, or software executing on a system of one or more computers, which is in communication with, or maintains, one or more databases. The UAV primary computer system 300 can include a processing subsystem 330 including one or more processors 335, graphics processing units 336, I/O subsystem 334, and an inertial measurement unit (IMU) 332. In addition, the UAV primary computer system 300 can include logic circuits, analog circuits, associated volatile and/or non-volatile memory, associated input/output data ports, power ports, etc., and include one or more software processes executing on one or more processors or computers. The UAV primary computer system 300 can include memory 318.

Memory 318 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The UAV primary computer system 300 may be coupled to one or more sensors, such as global navigation satellite system (GNSS) receivers 350 (e.g., GPS receivers), thermometer 354, gyroscopes 356, accelerometers 358, pressure sensors (static or differential) 352, and other sensors 395 that capture perception inputs of a physical environment. The other sensors 395 can include current sensors, voltage sensors, magnetometers, hydrometers, anemometers and motor sensors. The UAV may use IMU 332 in inertial navigation of the UAV. Sensors can be coupled to the UAV primary computer system 300, or to controller boards coupled to the UAV primary computer system 300. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 300 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 322 handles flight control operations of the UAV. The module interacts with one or more controllers 340 that control operation of motors 342 and/or actuators 344. For example, the motors may be used for rotation of propellers, and the actuators may be used for flight surface control such as ailerons, rudders, flaps, landing gear and parachute deployment.

The contingency module 324 monitors and handles contingency events. For example, the contingency module 324 may detect that the UAV has crossed a boundary of a geofence, and then instruct the flight control module 322 to return to a predetermined landing location. The contingency module 324 may detect that the UAV has flown or is flying out of a visual line of sight (VLOS) from a ground operator, and instruct the flight control module 322 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 329 processes the flight plan, waypoints, and other associated information with the flight plan as provided to the UAV in a flight package. The mission module 329 works in conjunction with the flight control module 322. For example, the mission module may send information concerning the flight plan to the flight control module 322, for example waypoints (e.g., latitude, longitude and altitude), flight velocity, so that the flight control module 322 can autopilot the UAV.

The UAV may have various devices connected to the UAV for performing a variety of tasks, such as data collection. For example, the UAV may carry one or more cameras 349. Cameras 349 can include one or more visible light cameras 349A, which can be, for example, a still image camera, a video camera, or a multispectral camera. The UAV may carry one or more infrared cameras 349B. Each infrared camera 349B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 318 of the UAV primary computer system 300.

The UAV primary computer system 300 may be coupled to various radios, e.g., transceivers 359 for manual control of the UAV, and for wireless or wired data transmission to and from the UAV primary computer system 300, and optionally a UAV secondary computer system 302. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 320 and storing the information in computer-readable media (e.g., non-volatile memory 318). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 320. In some implementations, the operating system 320 can be a real time operating system (RTOS), UNIX, LINUX, OS X, WINDOWS, ANDROID or other operating system 320. Additionally, other software modules and applications may run on the operating system 320, such as a flight control module 322, contingency module 324, inspection module 326, database module 328 and mission module 329. In particular, inspection module 326 can include computer instructions that, when executed by processor 335, can cause processor 335 to control the UAV to perform solar panel inspection operations as described below. Typically, flight critical functions will be performed using the UAV primary computer system 300. Operating system 320 may include instructions for handling basic system services and for performing hardware dependent tasks.

In addition to the UAV primary computer system 300, the secondary computer system 302 may be used to run another operating system 372 to perform other functions. The UAV secondary computer system 302 can be a system of one or more computers, or software executing on a system of one or more computers, which is in communication with, or maintains, one or more databases. The UAV secondary computer system 302 can include a processing subsystem 390 of one or more processors 394, GPU 392, and I/O subsystem 393. The UAV secondary computer system 302 can include logic circuits, analog circuits, associated volatile and/or non-volatile memory, associated input/output data ports, power ports, etc., and include one or more software processes executing on one or more processors or computers. The UAV secondary computer system 302 can include memory 370. Memory 370 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 302 will be non-critical functions in nature. If the function fails, the UAV will still be able to operate safely. The UAV secondary computer system 302 can include operating system 372. In some implementations, the operating system 372 can be based on real time operating system (RTOS), UNIX, LINUX, OS X, WINDOWS, ANDROID or other operating system.

Additionally, other software modules and applications may run on the operating system 372, such as an inspection module 374, database module 376, mission module 378 and contingency module 380. In particular, inspection module 374 can include computer instructions that, when executed by processor 394, can cause processor 394 to control the UAV to perform solar panel inspection operations as described below. Operating system 372 may include instructions for handling basic system services and for performing hardware dependent tasks.

The UAV can include controllers 346. Controllers 346 may be used to interact with and operate a payload device 348, and other devices such as cameras 349A and 349B. Cameras 349A and 349B can include a still-image camera, video camera, infrared camera, multispectral camera, stereo camera pair. In addition, controllers 346 may interact with a Lidar, radio transceiver, sonar, laser ranger, altimeter, TCAS, ADS-B (Automatic dependent surveillance-broadcast) transponder. Optionally, the secondary computer system 302 may have controllers to control payload devices.

The UAV 100 illustrated in FIGS. 1-3 is an example provided for illustrative purposes. The UAV 100 in accordance with the present disclosure may include more or fewer components than are shown. For example, while a quadcopter is illustrated, the UAV 100 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 100 may be guided by other types of vehicles (e.g., spacecraft, land vehicles, watercraft, submarine vehicles, etc.).

The following paragraphs describe dynamic obstacle avoidance in UAVs. The system may be used to perform these operations is described herein such as the UAV 100 of FIGS. 1-3.

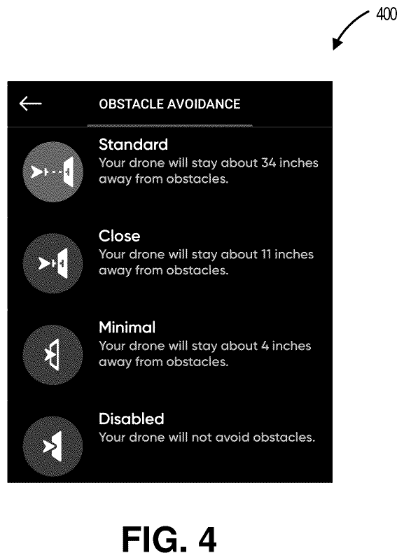

Referring now to FIG. 4, the figure illustrates various obstacle avoidance modes for an unmanned aerial vehicle (UAV), each mode specifying a distinct distance that the UAV maintains from obstacles. The Standard mode ensures the UAV maintains a distance of approximately 34 inches from obstacles, providing a broad safety margin suitable for general navigation. The Close mode reduces this distance to about 11 inches, allowing the UAV to operate in tighter spaces while still maintaining a buffer for safety. Minimal mode further decreases the distance to approximately 4 inches, enabling the UAV to navigate through very confined areas, such as narrow doorways, which aligns with the dynamic reduced obstacle mode or doorway mode. Finally, the Disabled mode allows the UAV to operate without any obstacle avoidance, which may be useful in controlled environments where obstacles are not a concern.

The dynamic modification of obstacle margins is exemplified by these modes. The UAV can dynamically adjust its obstacle margin based on detected conditions, such as environmental factors or user input, to navigate through confined areas effectively. For instance, in the doorway mode, the UAV automatically shrinks its obstacle margin to fit through narrow spaces. This is achieved by reducing the size of the obstacle map to enhance resolution and improve detection of confined spaces, allowing for precise navigation.

The system's ability to limit the UAV's maximum speed to a predetermined value when in reduced obstacle mode is crucial for maintaining control and safety. This feature ensures that the UAV does not exceed a safe speed while navigating through tight spaces, reducing the risk of collision. Additionally, the system can automatically return the UAV to its previous mode once the reduced obstacle mode can be exited, ensuring seamless transition and operation continuity.

Overall, the interaction between these modes and the UAV's dynamic obstacle avoidance capabilities highlights the system's flexibility and adaptability. By allowing user input to toggle between modes or temporarily reduce the obstacle margin, the system provides enhanced control and customization, catering to various operational needs and environmental conditions. This comprehensive approach to obstacle avoidance ensures optimal UAV performance and safety across different scenarios.

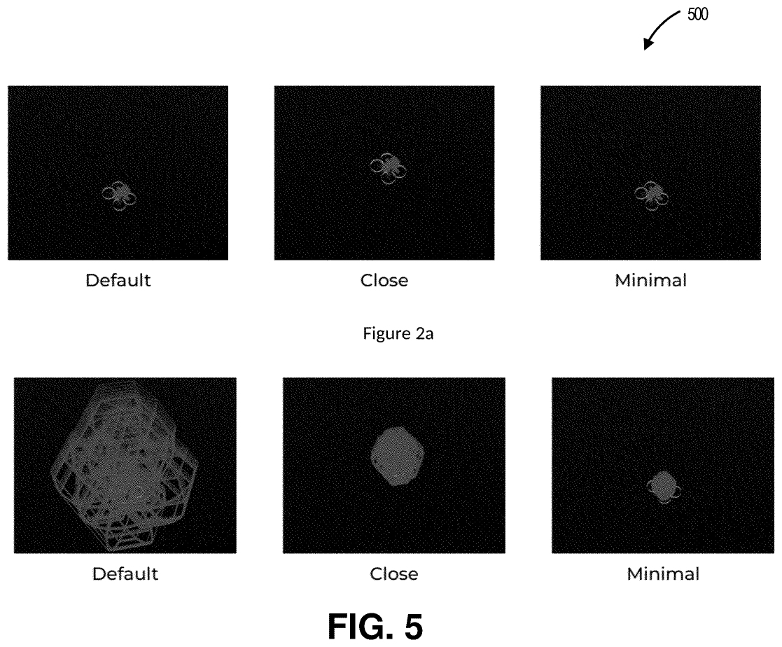

Referring now to FIG. 5, the illustration depicts various obstacle avoidance modes for a UAV, specifically labeled as Default, Close, and Minimal. These modes represent different levels of obstacle margins that can be dynamically adjusted based on environmental conditions or user input. The Default mode likely indicates standard obstacle margins, providing a baseline level of safety and spatial awareness for the UAV. In contrast, the Close and Minimal modes suggest progressively reduced margins, which are particularly useful for navigating tighter spaces or confined areas, such as doorways or narrow passages.

The upper row of FIG. 5 shows the UAV in three distinct modes: Default, Close, and Minimal. Each mode is visually represented by the size and configuration of the UAV's obstacle margins. Default mode appears to have the largest margin, providing a comprehensive buffer zone around the UAV. This mode is likely used in open environments where maximum safety is prioritized. The Close mode reduces this margin, allowing the UAV to operate in moderately confined spaces while still maintaining a level of safety. The Minimal mode further reduces the margins, enabling the UAV to navigate through very tight spaces, such as narrow doorways, by dynamically shrinking the obstacle margins.

The lower row of FIG. 5 provides a visual representation of the obstacle detection capabilities in each mode. The Default mode shows a complex network of red lines, indicating a robust detection system that covers a wide area around the UAV. This extensive coverage is essential for detecting obstacles in open environments. The Close mode displays a more compact detection area, suitable for environments where obstacles are closer but not densely packed. The Minimal mode shows the smallest detection area, focusing on immediate surroundings to allow precise navigation through confined spaces. This aligns with the capability to dynamically modify obstacle margins and adjust the obstacle map size for enhanced resolution and detection accuracy.

Overall, FIG. 5 illustrates the UAV's ability to adapt its obstacle avoidance strategy dynamically, based on real-time conditions and user inputs. This adaptability is crucial for maintaining optimal performance and safety across various environments. The interaction between the different modes and the UAV's detection capabilities ensures that the UAV can efficiently navigate through both open and confined spaces, automatically adjusting its behavior to suit the detected conditions.

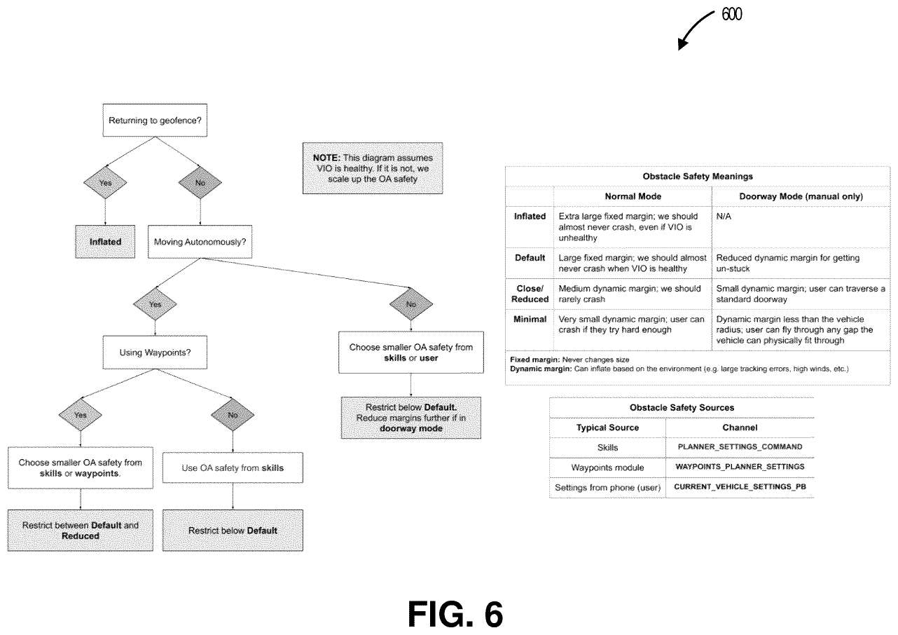

The flowchart in FIG. 6 illustrates a dynamic approach to obstacle avoidance for unmanned aerial vehicles (UAVs), focusing on adjusting safety margins based on various conditions. This process particularly emphasizes the dynamic modification of obstacle margins and the adjustment of obstacle avoidance levels based on detected conditions. The flowchart begins with a decision point on whether the UAV is returning to a geofence. If the UAV is returning, the obstacle margins are inflated, indicating an extra-large fixed margin to prevent crashes even if the visual inertial odometry (VIO) is unhealthy. This aligns with the concept of dynamically modifying obstacle margins based on certain conditions or triggering events.

If the UAV is not returning to a geofence, the flowchart checks if the UAV is moving autonomously. If it is, the next decision point is whether the UAV is using waypoints. Depending on these conditions, the UAV chooses a smaller obstacle avoidance (OA) safety margin from skills or user input. This decision-making process is crucial for dynamically determining the detected conditions and automatically adjusting the level of obstacle avoidance. The flowchart further includes instructions to restrict margins below default, especially in doorway mode, which is a key feature of the dynamic reduced obstacle mode. In doorway mode, the UAV automatically shrinks the obstacle margins to fit through narrow spaces, such as doorways, and limits its maximum speed to a predetermined value, enhancing precision and safety.

The flowchart also provides a table explaining the meanings of different obstacle safety levels, such as inflated, default, close/reduced, and minimal. These levels correspond to various modes, including normal and doorway modes, and are adjusted based on environmental factors like tracking errors or high winds. This dynamic adjustment of obstacle margins allows the UAV to adapt to real-time conditions and improve its navigation through confined areas. Additionally, the flowchart outlines the typical sources and channels for obstacle safety settings, such as skills, waypoints module, and settings from a phone, which contribute to the UAV's ability to dynamically modify its obstacle margins and adjust its obstacle avoidance strategies.

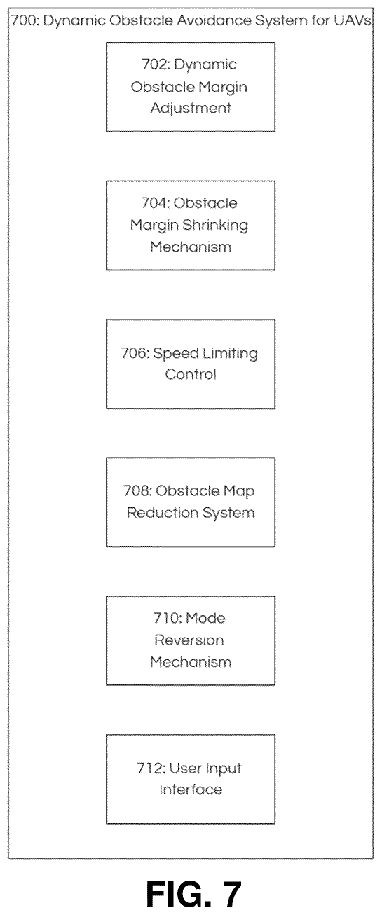

FIG. 7 is a diagram illustrating the Dynamic Obstacle Margin Adjustment system, according to an embodiment. The system may adjust obstacle margins dynamically based on detected conditions. The detected conditions may be dynamically determined, allowing the system to automatically adjust the level of obstacle avoidance. The obstacle margin may be dynamically modified based on certain conditions or triggering events, such as when the vehicle is navigating through confined areas. The system may include a mechanism to automatically shrink the obstacle margins to navigate narrow spaces, such as in a doorway mode. This may involve automatically shrinking the margins to fit through narrow spaces, enabling the vehicle to traverse these areas effectively.

Additionally, the system may incorporate a Speed Limiting Control, which may limit the UAV's speed to a predetermined value for safety. This control may cap the maximum speed to a pre-determined value, ensuring safe operation in reduced obstacle mode. The Obstacle Map Reduction System may reduce the size of the obstacle map to enhance resolution and improve detection of confined spaces. This reduction may provide finer resolution, allowing for more accurate detection of obstacles in the environment.

The Mode Reversion Mechanism may automatically revert the UAV to the previous mode after exiting the reduced mode. This mechanism may detect when the reduced obstacle mode can be exited and may autonomously return the vehicle to the mode it was in prior to the triggering event. The User Input Interface may allow user control over obstacle avoidance modes and margins. Users may select between different modes or temporarily reduce the obstacle margin by interacting with the controller. This interface may provide user control over obstacle avoidance modes, enhancing the flexibility and adaptability of the system.

The Dynamic Obstacle Margin Adjustment system may be integral to the UAV's ability to navigate complex environments safely and efficiently. By dynamically modifying obstacle margins and incorporating user input, the system may offer a robust solution for dynamic obstacle avoidance.

The Obstacle Margin Shrinking Mechanism, identified as component 704, may automatically shrink the obstacle margins to facilitate navigation through narrow spaces. This mechanism may be particularly effective when the vehicle enters a doorway mode, allowing it to fit through confined areas such as doorways. The shrinking of the obstacle margins may be dynamically adjusted based on the detected conditions, which may include the presence of narrow spaces or the activation of the doorway mode. The mechanism may work in conjunction with other components, such as the Speed Limiting Control and the Obstacle Map Reduction System, to ensure safe and efficient navigation. The Speed Limiting Control may limit the UAV's speed to a predetermined value, enhancing safety during navigation in reduced obstacle mode. Meanwhile, the Obstacle Map Reduction System may reduce the size of the obstacle map, thereby enhancing resolution and improving the detection of confined spaces. The integration of these components may allow the vehicle to dynamically modify its obstacle margins and adjust its navigation strategy based on real-time conditions. This dynamic adjustment may be crucial for maintaining optimal performance and safety in various environments. The system may also include a Mode Reversion Mechanism, which may automatically revert the vehicle to its previous mode once the reduced obstacle mode can be exited. This seamless transition between modes may be facilitated by the detection of triggering events, ensuring that the vehicle can adapt to changing conditions without manual intervention. Additionally, a User Input Interface may provide users with control over obstacle avoidance modes and margins, allowing for manual adjustments when necessary. This interface may enable users to toggle between different modes or temporarily reduce the obstacle margin to navigate specific areas. Overall, the Obstacle Margin Shrinking Mechanism, in conjunction with its associated components, may provide a comprehensive solution for dynamic obstacle avoidance in unmanned aerial vehicles.

The Speed Limiting Control component 706 may limit the UAV's speed to a predetermined value to ensure safety. This component may be crucial in scenarios where the UAV is navigating through confined spaces or operating in a reduced obstacle mode. The speed limitation may be achieved by capping the maximum speed to a predefined threshold, which may be determined based on the specific conditions or triggering events encountered by the UAV. This action may correlate with the action of limiting a maximum speed of the UAV, where the purpose is to maintain a controlled speed for safety. In the context of the current system, the speed limiting control may be implemented to ensure that the UAV does not exceed a safe velocity, particularly when operating in environments that require precise maneuvering. The component may work in conjunction with other systems, such as the obstacle margin adjustment and obstacle map reduction systems, to provide a comprehensive approach to dynamic obstacle avoidance. The integration of these systems may allow the UAV to adapt its speed dynamically, ensuring that it can navigate safely and efficiently through various operational scenarios.

The Obstacle Map Reduction System, identified as component 708, may play a role in enhancing the detection capabilities of the unmanned aerial vehicle (UAV) by reducing the size of the obstacle map. This reduction may allow for a finer resolution, which can improve the accuracy of detecting confined spaces. The system may dynamically adjust the obstacle map size based on detected conditions, which may include environmental factors or specific triggering events. This dynamic adjustment may be essential for navigating through narrow spaces, such as doorways, where precision is paramount.

The system may correlate with the actions of dynamically determining conditions and adjusting obstacle margins, as well as dynamically modifying the obstacle margin based on certain conditions or triggering events. These actions may be integral to the system's ability to enhance obstacle detection accuracy. The reduction in obstacle map size may be achieved through a process that involves analyzing the current environmental conditions and making real-time adjustments to the map's resolution.

In the context of the current system, the Obstacle Map Reduction System may be designed to work in conjunction with other components, such as the Dynamic Obstacle Margin Adjustment and the Obstacle Margin Shrinking Mechanism. Together, these components may form a cohesive system that allows the UAV to navigate through confined areas with increased safety and efficiency. The system may also be capable of reverting to a previous mode once the reduced obstacle mode can be exited, ensuring that the UAV can adapt to changing conditions seamlessly.

Overall, the Obstacle Map Reduction System may be a component in the UAV's dynamic obstacle avoidance capabilities, providing enhanced detection and navigation through confined spaces by leveraging real-time data and adaptive algorithms.

The Mode Reversion Mechanism, identified as component 710, may automatically revert the unmanned aerial vehicle (UAV) to its previous mode after the reduced obstacle mode is exited. This mechanism may involve the UAV detecting when the reduced obstacle mode can be exited, which may be triggered by certain conditions or events. The UAV may then autonomously return to the mode it was in prior to the triggering event, ensuring seamless transition and continuity in operation. The mechanism may be designed to enhance the UAV's adaptability by allowing it to dynamically adjust its operational mode based on real-time conditions. This capability may be crucial for maintaining optimal performance and safety, particularly in environments where the UAV must navigate through confined spaces or adjust to varying obstacle margins. The Mode Reversion Mechanism may work in conjunction with other components, such as the Dynamic Obstacle Margin Adjustment and the Obstacle Margin Shrinking Mechanism, to provide a comprehensive system for dynamic obstacle avoidance. The UAV may utilize this mechanism to ensure that it can efficiently and effectively navigate through different environments while maintaining the ability to revert to a more suitable mode when necessary. This process may involve the UAV's system dynamically determining the conditions that necessitate a mode change and executing the reversion autonomously, thereby enhancing the UAV's operational flexibility and safety.

The User Input Interface component 712 may facilitate user control over obstacle avoidance modes and margins in the UAV system. This component may allow a user to interact with the system through a controller, which may include a button for toggling between various obstacle avoidance modes. The user may also have the capability to temporarily reduce the obstacle margin, which may be particularly useful when navigating through confined spaces or narrow passages. The interface may be designed to provide intuitive control, enabling the user to select between different modes, thereby offering flexibility in operation. The system may dynamically adjust the obstacle margins based on user input, which may enhance the UAV's ability to navigate through challenging environments. The user input may be processed to modify the obstacle margin dynamically, ensuring that the UAV can adapt to real-time conditions and maintain optimal performance. This interaction may be crucial for scenarios where manual intervention is required to navigate complex environments, allowing the UAV to operate safely and efficiently. The User Input Interface component 712 may thus play a role in providing user-driven control over the UAV's obstacle avoidance capabilities, ensuring adaptability and precision in various operational contexts.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately)) 225°. The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

What is claimed is:

1. A method for dynamic obstacle avoidance in an unmanned aerial vehicle (UAV), comprising:
dynamically modifying an obstacle margin based on detected conditions to enable navigation through confined areas;
automatically shrinking the obstacle margin when the UAV is in a reduced obstacle mode;
limiting a maximum speed of the UAV to a predetermined value when in the reduced obstacle mode;
reducing a size of an obstacle map to enhance resolution and improve detection of confined spaces;
dynamically determining the detected conditions to automatically adjust a level of obstacle avoidance;
automatically adjusting the level of obstacle avoidance to adapt to the detected conditions;
detecting when the reduced obstacle mode can be exited; and
automatically returning the UAV to a previous mode upon detecting that the reduced obstacle mode can be exited.

2. The method of claim 1, wherein the detected conditions comprise at least one of an impeded movement of the UAV or an intended path of the UAV through a restricted opening.

3. The method of claim 1, wherein dynamically modifying the obstacle margin comprises adaptively adjusting the obstacle margin based on the confined area.

4. The method of claim 1, wherein automatically shrinking the obstacle margin comprises dynamically reducing the obstacle margin.

5. The method of claim 1, wherein limiting the maximum speed of the UAV comprises setting an adjustable limit for a reduced velocity of the UAV.

6. The method of claim 1, wherein reducing the size of the obstacle map comprises enhancing a precision of the obstacle map for improved recognition of the confined spaces.

7. The method of claim 1, wherein dynamically determining the detected conditions comprises autonomously recognizing criteria for a change in the obstacle avoidance mode.

8. The method of claim 1, wherein automatically returning the UAV to the previous mode comprises autonomously reverting to the previous mode.

9. The method of claim 1, further comprising:
receiving a user input from a controller to temporarily reduce the obstacle margin.

10. The method of claim 1, further comprising:
receiving a user input from a controller to toggle between a plurality of obstacle avoidance modes.

11. A system for dynamic obstacle avoidance in an unmanned aerial vehicle (UAV), comprising:
a processor configured to:
dynamically modify an obstacle margin based on detected conditions to enable navigation through confined areas;
automatically shrink the obstacle margin when the UAV is in a reduced obstacle mode;
limit a maximum speed of the UAV to a predetermined value when in the reduced obstacle mode;
reduce a size of an obstacle map to enhance resolution and improve detection of confined spaces;
dynamically determine the detected conditions to automatically adjust a level of obstacle avoidance;
automatically adjust the level of obstacle avoidance to adapt to the detected conditions;
detect when the reduced obstacle mode can be exited; and
automatically return the UAV to a previous mode upon detecting that the reduced obstacle mode can be exited.

12. The system of claim 11, wherein the detected conditions comprise at least one of an impeded movement of the UAV or an intended path of the UAV through a restricted opening.

13. The system of claim 11, wherein dynamically modifying the obstacle margin comprises adaptively adjusting the obstacle margin based on the confined area.

14. The system of claim 11, wherein automatically shrinking the obstacle margin comprises dynamically reducing the obstacle margin.

15. The system of claim 11, wherein limiting the maximum speed of the UAV comprises setting an adjustable limit for a reduced velocity of the UAV.

16. The system of claim 11, wherein reducing the size of the obstacle map comprises enhancing a precision of the obstacle map for improved recognition of the confined spaces.

17. The system of claim 11, wherein dynamically determining the detected conditions comprises autonomously recognizing criteria for a change in the obstacle avoidance mode.

18. The system of claim 11, wherein automatically returning the UAV to the previous mode comprises autonomously reverting to the previous mode.

19. The system of claim 11, wherein the processor is further configured to:
receive a user input from a controller to temporarily reduce the obstacle margin; and
receive a user input from a controller to toggle between a plurality of obstacle avoidance modes.

20. An apparatus comprising:
one or more computer-readable media; and
program instructions stored on the one or more computer-readable storage media that, when executed by one or more processors of an aerial vehicle, direct the one or more processors to at least:
dynamically modifying an obstacle margin based on detected conditions to enable navigation through confined areas;
automatically shrinking the obstacle margin when the UAV is in a reduced obstacle mode;
limiting a maximum speed of the UAV to a predetermined value when in the reduced obstacle mode;
reducing a size of an obstacle map to enhance resolution and improve detection of confined spaces;
dynamically determining the detected conditions to automatically adjust a level of obstacle avoidance;
automatically adjusting the level of obstacle avoidance to adapt to the detected conditions;
detecting when the reduced obstacle mode can be exited; and
automatically returning the UAV to a previous mode upon detecting that the reduced obstacle mode can be exited.
